(19) United States
(12) Patent Application Publication
(10) Pub. No.: US 2006/0145562 A1
(43) Pub. Date: Jul. 6, 2006

(54) A STATOR STRUCTURE OF AN AXIAL GAP ROTATING ELECTRICAL DEVICE

(75) Inventor: Hiroyuki Nakayama, Yokosuka-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/299,271

(22) Filed: Dec. 9, 2005

(30) Foreign Application Priority Data
Dec. 10, 2004 (JP) 2004-358245

(51) Int. Cl. H02K 21/12; H02K 1/00; H02K 1/28

(52) U.S. Cl. 310/218; 310/268; 310/216; 310/156.35

(57) ABSTRACT

A stator structure of an axial gap rotating electrical device is described that enables the controlling of a loop current generated at the contact area between a laminated surface of stator teeth and that of a stator back core. The stator structure may also inhibit eddy-current loss and eventually iron loss. Providing insulation at the contact area, between the laminated surface of stator teeth and the stator back core, may control the loop current and inhibit eddy-current loss. The disclosure describes a stator structure of an axial gap rotating electrical device comprising a stator that includes one or more stator teeth are fixed to interface fit holes bored in a stator back core, wherein a loop current decrease layer is formed between a laminated surface of the stator teeth and the stator back core within an interface fit area.

This application claims priority from Japanese Patent Application No. 2004-358245, filed Dec. 10, 2004, the entire contents of which is incorporated herein by reference.

### TECHNICAL FIELD

The disclosure relates to electricity generation, and more specifically, devices which utilize stators and a rotor to generate electricity.

### BACKGROUND

Electricity may be generated with rotating electrical generation devices. These devices may include stators positioned around a disc-like rotor along a rotational axis. A stator may be constructed with multiple layers of a metal. As the rotor rotates along the axis, an electrical current is produced through interaction of magnets attached to the rotor with the stators. This electrical current is the electricity that may be used or stored for other purposes.

### SUMMARY

In one embodiment, the disclosure is directed to an axial gap rotating electrical device comprising a stator that includes one or more stator teeth fixed to interface fit holes bored in a stator back core, wherein an insulating layer is formed between a laminated surface of the stator teeth and the stator back core within an interface fit area.

In another embodiment, the disclosure is directed to a stator structure of an axial gap rotating electrical device comprising means to rotate a plurality of permanent magnets, means to generate an electrical current, and means to prevent a loop current within an interface fit area of the means to generate an electrical current.

In an alternative embodiment, the disclosure is directed to an electrical device comprising a stator that includes one or more stator teeth are fixed to interface fit holes bored in a stator back core, wherein the stator teeth laminates multiple layers of a metal and the stator back laminates multiple layers of a metal, a rotor having a plurality of permanent magnets evenly placed on a disk-like holding member in a circumferential direction, wherein the holding member is coupled to a rotation axis and the stator is placed opposite the rotor along a central axis line of the rotor, a motor case that holds the rotation axis and fixes the stator back core in place, and a loop current decrease layer formed between a laminated surface of the stator teeth and the stator back core within an interface fit area.

One of the effects of an embodiment of the invention may provide certain advantages. These advantages may include inhibiting loop current loss between stator teeth and a stator back core, so as to reduce the amount of heat generated in the electrical device. In addition, reducing the loop current may reduce the amount of iron loss within the electric device.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is an exemplary illustration of a sectional view showing one embodiment of an axial gap rotating electrical device.

FIG. 2 is a sectional view showing an embodiment for a stator structure of an axial gap rotating electrical device.

FIGS. 3a and 3b are perspective views showing a top view and sectional view, respectively, of one embodiment of an axial gap rotating electrical device.

FIGS. 4a and 4b are perspective views showing a top view and sectional view, respectively, of one embodiment of an axial gap rotating electrical device.

FIGS. 5a and 5b are perspective views showing a top view and sectional view, respectively, of one embodiment of an axial gap rotating electrical device.

FIGS. 6a and 6b are perspective views showing a top view and sectional view, respectively, of one embodiment of an axial gap rotating electrical device.

FIGS. 7a and 7b are perspective views showing a top view and sectional view, respectively, of one embodiment of an axial gap rotating electrical device.

FIGS. 8a and 8b are perspective views showing a top view and sectional view, respectively, of one embodiment of an axial gap rotating electrical device.

FIGS. 9a and 9b are perspective views showing a top view and sectional view, respectively, of one embodiment of an axial gap rotating electrical device.

FIGS. 10a and 10b are perspective views showing a top view and sectional view, respectively, of one embodiment of an axial gap rotating electrical device.

FIGS. 11a and 11b are perspective views showing a top view and sectional view, respectively, of one embodiment of an axial gap rotating electrical device.

FIGS. 12a and 12b are perspective views showing a top view and sectional view, respectively, of one embodiment of an axial gap rotating electrical device.

FIGS. 13a and 13b are perspective views showing a top view and sectional view, respectively, of one embodiment of an axial gap rotating electrical device.

FIGS. 14a and 14b are perspective views showing a top view and sectional view, respectively, of one embodiment of an axial gap rotating electrical device.

FIG. 15 is a sectional view showing an embodiment for a stator structure of an axial gap rotating electrical device, where there is no insulation around each stator.

### DETAILED DESCRIPTION

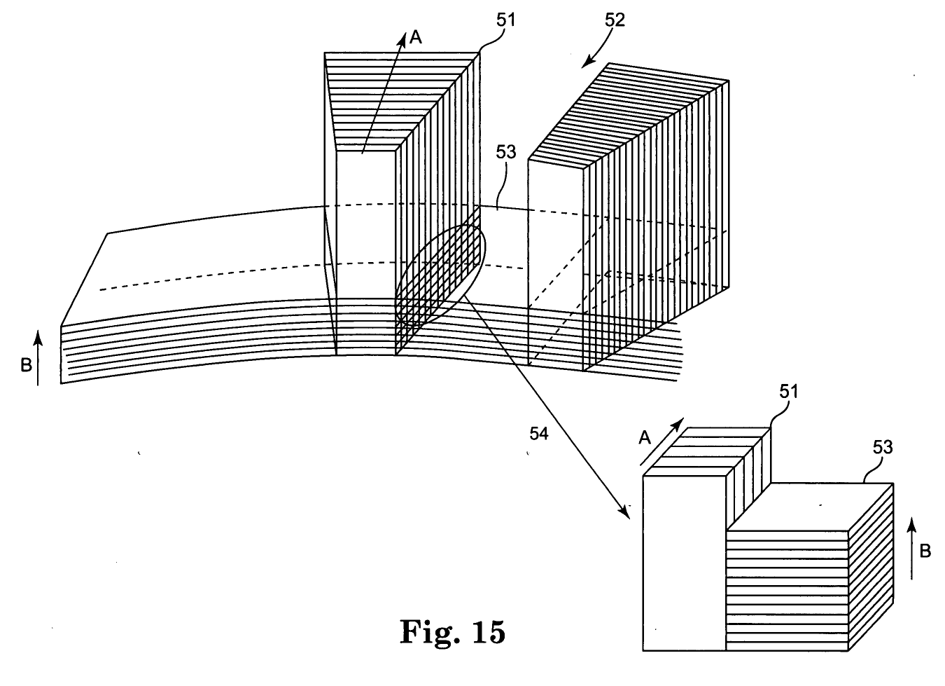

FIG. 15 illustrates a rotating electrical device, including a stator and a rotor that generates heat due to core loss, copper loss, or mechanical loss. Axial gap rotating electrical devices include a stator and a disk-like rotor which are placed opposite each other along a rotation axis, wherein the stator is formed by layering electromagnetic steel plates. Stator teeth 51 are structured by layering electromagnetic steel plates in a radial direction A of a stator 52, layering electromagnetic steel plates in a direction of central axis line B of the stator 52, and bonding the stator teeth 51 to the interface fit holes bored in a stator back core 53.

In an interface fit area 54 of the stator teeth 51 and stator back core 53, the laminated surface of the stator teeth 51 and that of the stator back core 53 make contact in a way such that their respective lamination crosses at right angles when the stator teeth 51 are jointed to the stator back core 53 by the interface fit. Accordingly, the electromagnetic steel plate constituting the stator teeth 51 facilitates an electric current in a central axis line direction B of the stator 52, while the electromagnetic steel plate constituting the stator back core 53 facilitates an electric current in a radial direction A of the stator 52. A flux, derived from an excitation current of the stator 52, generates a loop current at the contact area, such as the interface area, between the laminated surface of the stator teeth 51 and that of the stator back core. This loop current may increase eddy-current loss and eventually iron loss. The laminated surface refers to one or more layers comprising layered laminated steel plates as well as a circumferential edge of the stator teeth and that of the interface fit holes bored in the stator back core. Electricity may be generated by a rotor passing by stator teeth 51.

An embodiment of the present invention may solve problems of current loss and provide a stator structure of an axial gap rotating electrical device that enables the controlling of the loop current derived from the contact area between the laminated surface of the stator teeth and that of the stator back core. The disclosure may also increase inhibition of eddy-current loss and thus iron loss.

For the stator structure of the axial gap rotating electrical device, when joining the stator teeth to the stator back core by the interface fit, it is possible to prevent the laminated surface of the stator teeth and that of the stator back core from making contact in a way such that their respective lamination crosses at right angles in the interface fit area of the stator teeth and stator back core. This may be done by means of installing a loop current decrease layer at the interface fit area, between the laminated surface of said stator teeth and that of said stator back core. Accordingly, in the interface fit area, the electromagnetic steel plates constituting the stator facilitate an electric current in a central axis line direction of the stator, while the electromagnetic steel plates constituting the stator back core facilitate an electric current in a radial direction of the stator. Then, a flux, derived from an excitation current of the stator, generates a loop current between the laminated surface of the stator teeth and that of the stator back core, which inhibits the increase of eddy-current loss and thus iron loss.

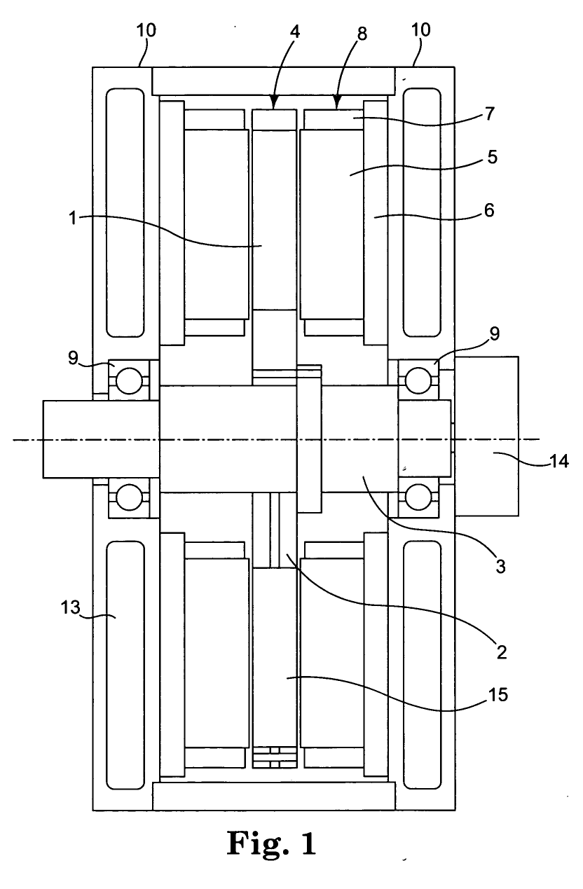

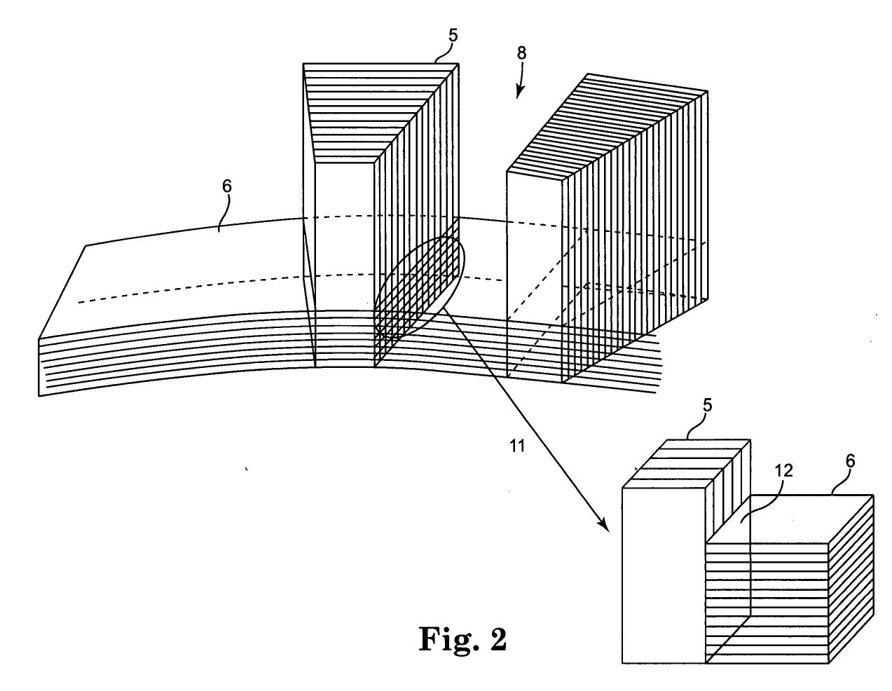

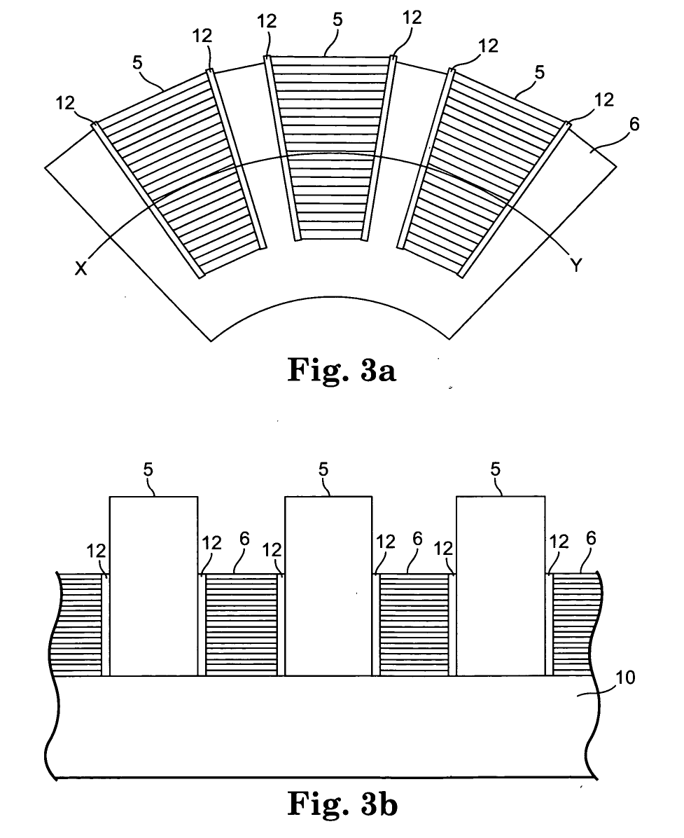

FIG. 1 is a sectional view of the axial gap rotating electrical device indicating an embodiment of the stator structure for the axial gap rotating electrical device according to the description herein. FIG. 2 is a perspective view of the stator for the axial gap rotating electrical device indicating an embodiment of the stator structure for the axial gap rotating electrical device according to the present invention. Further, FIG. 3 is a partial view of the stator structure for the axial gap rotating electrical device indicating an embodiment of the stator structure for the axial gap rotating electrical device according to the description herein.

As shown in FIG. 1, the stator structure of the axial gap rotating electrical device comprises rotor 4 having several permanent magnets 1 evenly placed on a disk-like holding member 2 in a circumferential direction, and composed by coupling said holding member to a rotation axis 3. FIG. 1 also includes stator 8 that is placed opposite a rotor 4 along the central axis line of the rotor, in which several stator teeth 5 formed by layered electromagnetic steel plates are evenly placed in a circumferential direction. Several of stator teeth 5 are fixed to the interface fit holes bored in a stator back core 6, which comprises layered electromagnetic steel plates, and a coil 7 that winds around respective stator teeth 5 to generate an electrical current, and a case 10 for holding said rotation axis 3 rotatably via a bearing 9 as well as fixing a stator 8. An insulating layer 12, made by an insulating sheet composed of material such as plastic or Kapton tape, is formed between the laminated surface of the stator teeth 5 and that of the stator back core 6 in the interface fit area 11 of the stator teeth 5 and stator back core 6, as shown in FIG. 2.

Rotor 4 in conjunction with rotation axis 3 may provide means to rotate a plurality of permanent magnets, and stator 8 may be added to provide means to generate an electrical current as the electrical device is intended to do. Insulating layer 12 may provide means to prevent a loop current within an interface fit area, wherein the interface fit area includes the contact area of stator teeth 5 and stator back core 6. Insulating layer 12 may also provide means to insulate the interface fit area.

It is thereby possible to prevent the laminated surface of the stator teeth 5 and that of the stator back core 6 from making contact in a way such that their respective lamination crosses at right angles in interface fit area 11 of the stator teeth 5 and stator back core 6, by means of installing an insulating layer 12 between the laminated surface of the stator teeth 5 and that of the stator back core 6 when joining the stator teeth 5 to the stator back core 6 by the interface fit. Accordingly, in the interface fit area 11, the electromagnetic steel plates constituting stator 8 facilitate an electric current in a central axis line direction of the stator 8, while the electromagnetic steel plates constituting the stator back core 6 facilitate an electric current in a radial direction of the stator 8. Then, a flux, derived from an excitation current of the stator 8, generates a loop current between the laminated surface of the stator teeth 5 and that of the stator back core 6, which inhibits the increase of eddy-current loss and thus iron loss.

For the axial gap rotating electrical device shown in FIG. 1, a pair of stators 8 are placed such that each stator 8 faces the rotor 4 and the case 9 has a cooling channel 13, which allows the coolant to circulate in order to absorb and cool down the heat lost from the stator teeth 5 and the coil 7. In addition, an encoder 14 is installed for detecting the rotation number and the position of the rotor 4 at the end of the rotation axis 3, and a rotor core 15, which comprises electromagnetic steel plates, is installed to use the reluctance torque between the permanent magnets 1 positioned next to the rotor 4 FIG. 3b shows the XY section of FIG. 3a.

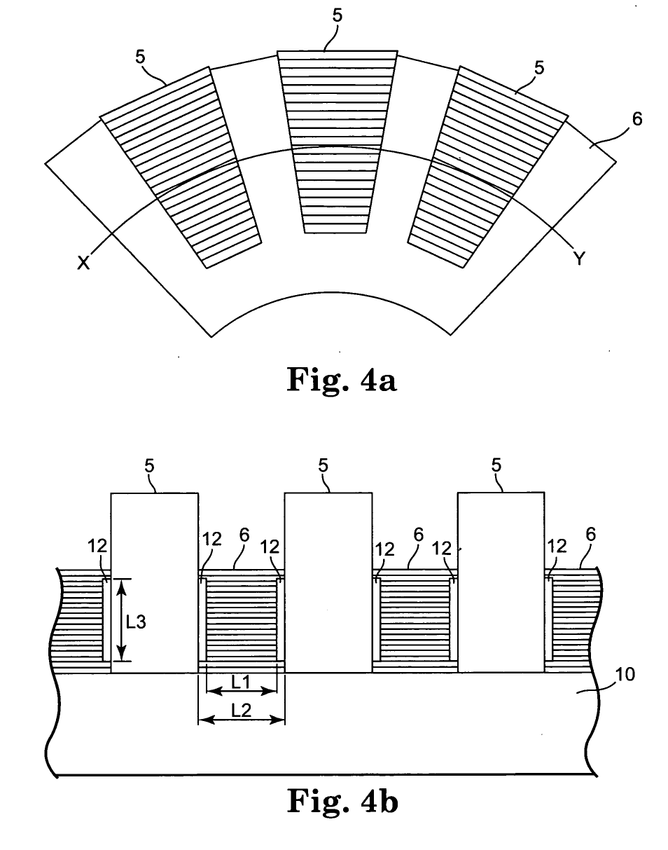

FIG. 4 is a partial view of the stator structure for the axial gap rotating electrical device indicating another embodiment of the stator structure for the axial gap rotating electrical device. FIG. 4b shows the XY section of FIG. 4a. Since the basic structures of the rotating electrical device and the stator structure are similar to those in FIGS. 1 to 3, only the differences will be described.

In order to create a depression in the contact area between the laminated surface of the stator teeth 5 and stator back core 6 in a circumferential direction of the stator, the circumferential length L1 of the laminated steel plate situated in the middle, except for the gap side and the backside, is made shorter than the circumferential length L2 of the laminated steel plate situated on the gap side and the backside. This occurs among the laminated steel plates composing the stator back core 6. Insulating layer 12 is installed solely to the depression as shown in FIG. 4b. The gap side refers to the side opposite the rotor, and the backside refers to the case 10 side.

It is thereby possible for the laminated surface of the stator teeth 5 and that of the stator back core 6 to make direct contact in the area of the gap side and the backside of the stator back core 6. The circumferential force acting on the stator teeth 5 can also be maintained with higher rigidity than the insulating layer 12 while the rotating electrical device operates, due to the aid of the electromagnetic steel plates situated on the gap side and the backside among those which compose the stator back core 6. As a result, the circumferential holding rigidity of the stator teeth 5 is enhanced in comparison with the stator structure in FIG. 3.

In order to retain the insulation performance of the laminated surface of the stator teeth 5 and that of the stator back core 6, it is preferable to make the length L3 in the central axis line direction of the depression as long as possible. This is the length of the insulating layer. In order to enhance the holding rigidity in a circumferential direction of the stator teeth 5, it is preferable to make said length L3 as short as possible. Accordingly, said length L3 is determined by a trade-off between insulation performance and holding rigidity.

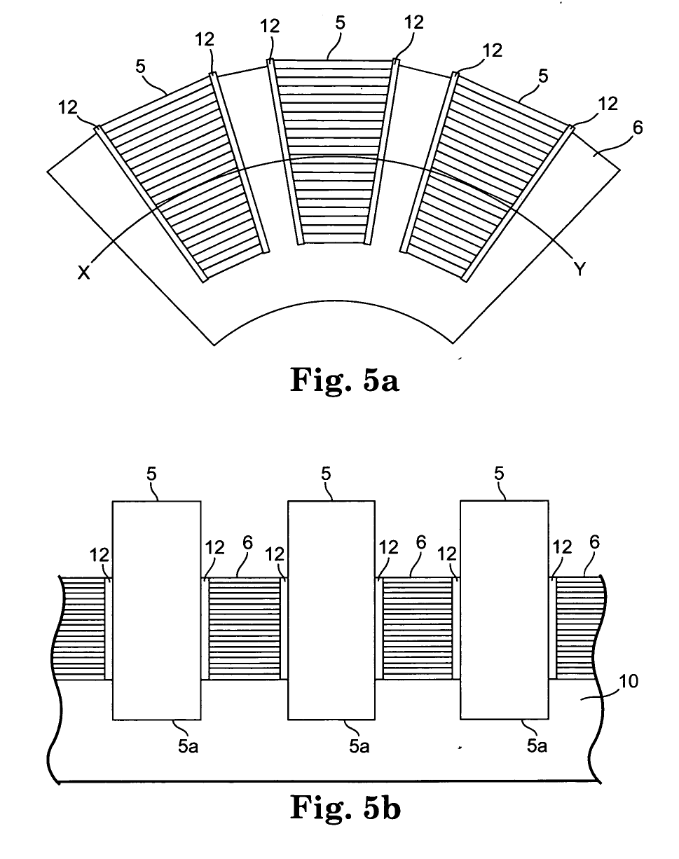

FIG. 5 is a partial view indicating another embodiment of the stator structure for the axial gap rotating electrical device according to the present invention. FIG. 5b shows the XY section of FIG. 5a. Since the basic structures of the rotating electrical device and the stator structure are similar to those in FIGS. 1 to 3, only the differences will be described.

The stator teeth 5 extend to the backside of the stator back core 6 in order to fix the prominent portion 5a on the backside of the stator teeth 5 to the additional interface fit holes, which are bored into the case 10, by means of the interface fit. In other words, stator teeth 5 may penetrate stator back core 6.

The circumferential force acting on the stator teeth 5 can thereby be maintained with high rigidity while the rotating electrical device operates, by means of the interface fit of the prominent portion 5a to the backside of the stator teeth 5 and the additional interface fit holes bored in the case 10, which results in higher holding rigidity in a circumferential direction of the stator teeth.

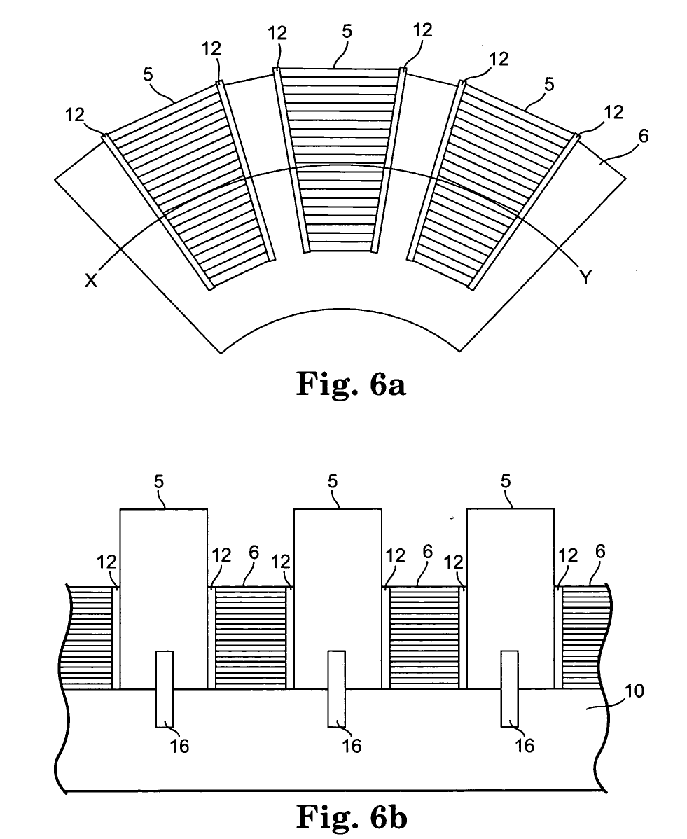

FIG. 6 is a partial view indicating another embodiment of the stator structure for the axial gap rotating electrical device according to the present invention. FIG. 6b shows the XY section of FIG. 6a. Since the basic structures of the rotating electrical device and the stator structure are similar to those in FIGS. 1 to 3, only the differences will be described.

In the backside area of the stator teeth 5 and the area facing the stator teeth 5 of the case 10, more than one pair of interface fit grooves extending in a radial direction of the stator 8 are created, and the stator teeth locking a plate 16 to the fitting grooves are fixed by means of the interface fit. The shape of the stator teeth correspond to that of the fitting grooves.

It is thereby possible to maintain the circumferential force acting on the stator teeth 5 with high rigidity while the rotating electrical device operates, by means of the stator teeth locking plate 16 being fitted to each groove on the stator case 5 and the case 10, which therefore enhances the holding rigidity in a circumferential direction of the stator teeth.

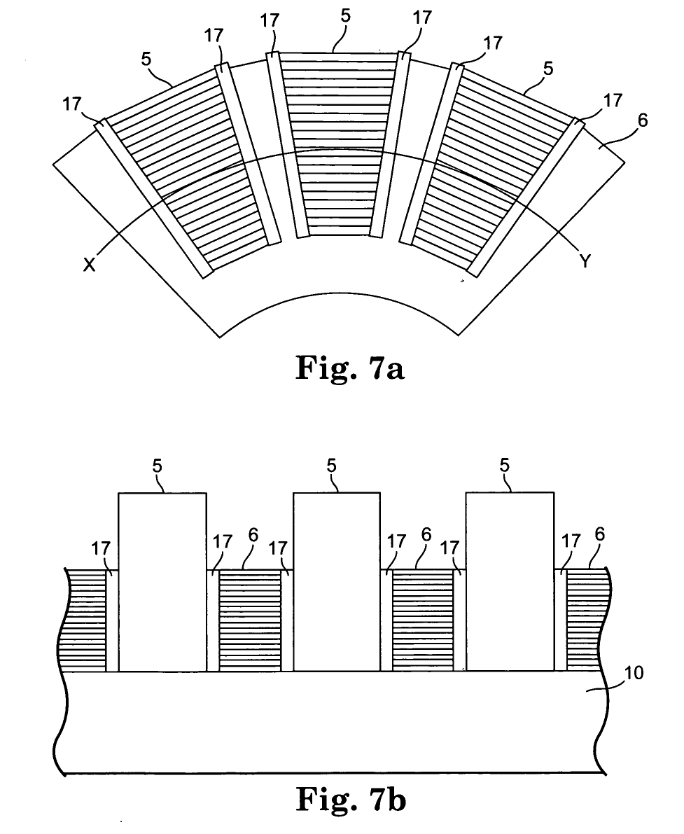

FIG. 7 is a partial summary view indicating another embodiment of the stator structure for the axial gap rotating electrical device according to the present invention. FIG. 7b shows the XY section of FIG. 7a.

As shown in FIG. 1, the stator structure of the axial gap rotating electrical device comprises a rotor 4 having several permanent magnets 1 evenly placed on a disk-like holding member 2 in a circumferential direction, and composed by coupling said holding member to a rotation axis 3. FIG. 1 also includes stator 8 that is placed opposite a rotor 4 along the central axis line of the rotor 4, in which several stator teeth 5 formed by layered electromagnetic steel plates are evenly placed in a circumferential direction. Several of said stator teeth 5 are fixed to the interface fit holes bored in the stator back core 6, which is composed of layered electromagnetic steel plates, and a coil 7 winds around respective stator teeth 5. In addition, FIG. 1 includes a case 10 for holding said rotation axis 3 rotatably via a bearing 9 as well as fixing said stator 8, wherein as shown in FIG. 7, a layer of dust material 17 is formed between the laminated surface of the stator teeth 5 and that of the stator back core 6 in the interface fit area of the stator teeth 5 and the stator back core 6. The dust material refers to a hardened mixture of magnetic powder such as iron powder and an insulator such as plastic. In addition, the dust material may act as an insulating layer in the interface fit area.

Similar to the structure corresponding to claim 1, when the stator teeth 5 are jointed to the stator back core 5 by the interface fit, the laminated surface of the stator teeth 5 and that of the stator back core 6 are prevented from making contact in a way such that the lamination of each crosses at right angles in the interface fit area of the stator teeth 5 and stator back core 6. This contact is prevented by means of installing a layer of dust material 17, or means to insulate the interface area, between the laminated surface of the stator teeth 5 and that of the stator back core 6. As a result, the electromagnetic steel plates constituting the stator 8 facilitate an electric current in a central axis line direction of the stator 8, while the electromagnetic steel plates constituting the stator 6 facilitate an electric current in a radial direction of the stator 8. Then, a flux, derived from an excitation current of the stator 8, generates a loop current between the laminated surface of the stator teeth 5 and that of the stator back core 6, which inhibits the increase of eddy-current loss and thus iron loss.

In addition, by installing the layer of dust material 17 that facilitates the flux in comparison with the insulating layer, the magnetic circuit structure formed by the stator teeth 5 and the stator back core 6 becomes more beneficial. In this case, the insulation layer is replaced by dust material 17.

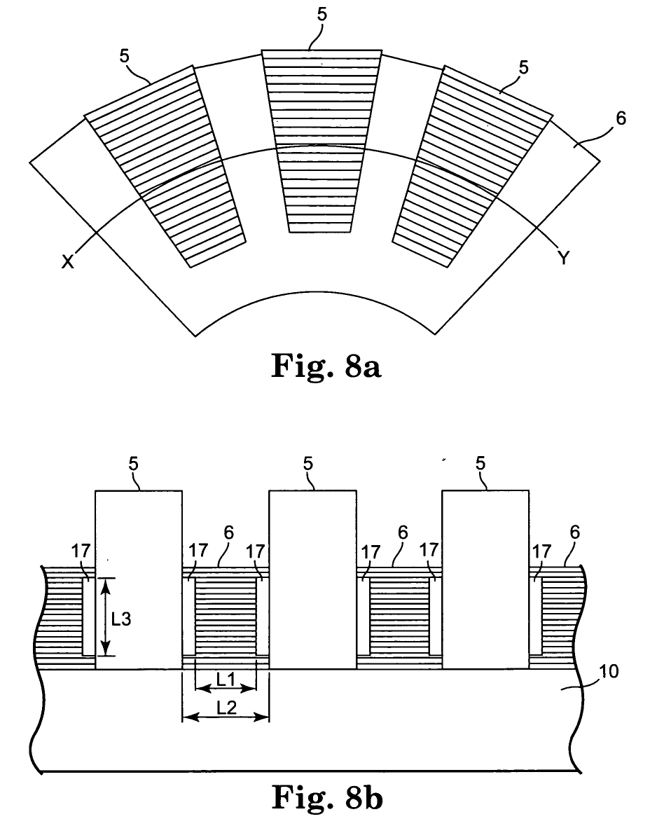

FIG. 8 is a partial view of the stator structure for the axial gap rotating electrical device indicating another embodiment of the stator structure for the axial gap rotating electrical device according to the present invention. FIG. 8b shows the XY section of FIG. 8a. Since the basic structures of the rotating electrical device and the stator are similar to those in FIGS. 1 and 7, only the differences will be described.

In order to create a depression in the contact area between the laminated surface of the stator teeth 5 and stator back core 6 in a circumferential direction of the stator, among the laminated steel plates composing the stator back core 6, the circumferential length L1 of the laminated steel plate situated in the middle, except the gap side and the backside, is made shorter than the circumferential length L2 of the laminated steel plate situated on the gap side and the backside, and a layer of dust material 12 is formed solely to said depression as shown in FIG. 8b.

The depression thereby allows the laminated surface of the stator teeth 5 and that of the stator back core 6 to come in direct contact in the area situated on the gap side and the backside of the stator back core. It is also possible to maintain the circumferential force acting on the stator teeth 5 with higher rigidity than the layer of dust material 17 while the rotating electrical device operates by using the electromagnetic steel plate situated on the gap side and the backside of the electromagnetic steel plates. Consequently, the holding rigidity in a circumferential direction of the stator teeth 5 is enhanced in comparison with the rotor structure shown in FIG. 7.

In order to retain insulation performance with the laminated surface of the stator teeth 5 and that of the stator back core 6, it is preferable to make the length L3 in the central axis line direction of said depression, that is the layer of dust material 17, as long as possible. However, to enhance the holding rigidity in a circumferential direction of the stator teeth 5, it is also preferable to make said length L3 as short as possible. Accordingly, said length L3 is determined by a trade-off between insulation performance and holding rigidity.

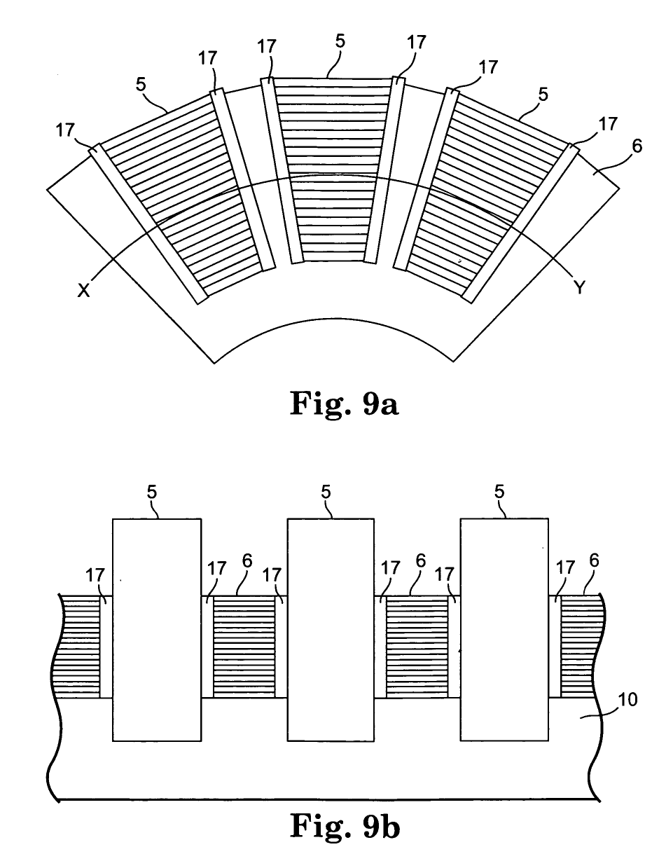

FIG. 9 is a partial view of the stator structure for the axial gap rotating electrical device indicating another embodiment of the stator structure for the axial gap rotating electrical device according to the present invention. FIG. 9b shows the XY section of FIG. 9(a). Since the basic structures of the rotating electrical device and the stator are similar to those in FIGS. 1 and 7, only the differences will be described.

The stator teeth 5 extend to the backside of the stator back core 6 in order to fix the prominent portion 5a on the backside of the stator teeth 5 to the additional holes, which are bored into the case 10, by means of the interface fit.

The circumferential force acting on the stator teeth 5 can thereby be maintained with high rigidity while the rotating electrical device operates, by means of the interface fit of the prominent portion 5a to the backside of the stator teeth 5 and the additional interface fit holes bored in the case 10, which achieves higher holding rigidity in a circumferential direction of the stator teeth.

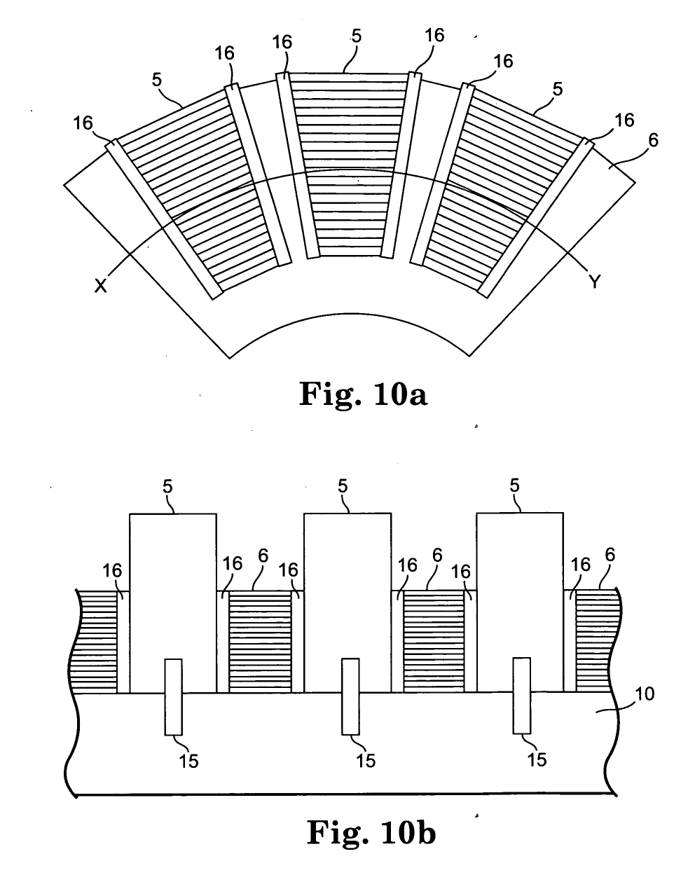

FIG. 10 is a partial view of the stator structure for the axial gap rotating electrical device indicating another embodiment of the stator structure for the axial gap rotating electrical device according to the present invention. FIG. 10b shows the XY section of FIG. 10a. Since the basic structures of the rotating electrical device and the stator are similar to those in FIGS. 1 and 7, only the differences will be described.

In the backside area of the stator teeth 5 and the area facing the stator teeth 5 of the case 10, more than one pair of the interface fit grooves extending in a radial direction of the stator 8 are created, and the stator teeth locking plate 16 is fixed to the fitting grooves by means of the interface fit.

It is thereby possible to maintain the circumferential force acting on the stator teeth 5 with high rigidity while the rotating electrical device operates, by means of the stator teeth locking plate 16 being fitted to each groove on the stator case 5 and the case 10, which results in the enhancement of holding rigidity in a circumferential direction of the stator teeth.

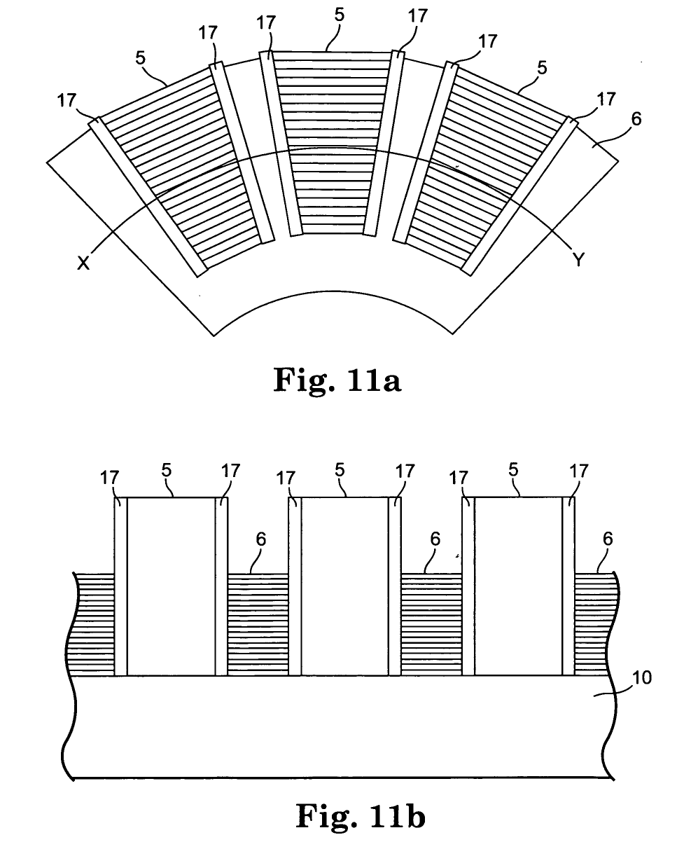

FIGS. 11 to 13 are partial views of the stator structure for the axial gap rotating electrical device indicating other embodiments of the stator structure for the axial gap rotating electrical device. FIGS. 11 to 13b show the XY section respectively. Since the basic structures of the rotating electrical device and the stator are similar to those in FIGS. 7, 9, and 10, only the differences will be described.

FIG. 11 indicates the layer of dust material 17, which is developed for covering not only the fitting area with the laminated surface of the stator teeth 5 and that of the stator back core 6, but also the overall laminated surface of the stator teeth 5 in the stator structure shown in FIG. 7.

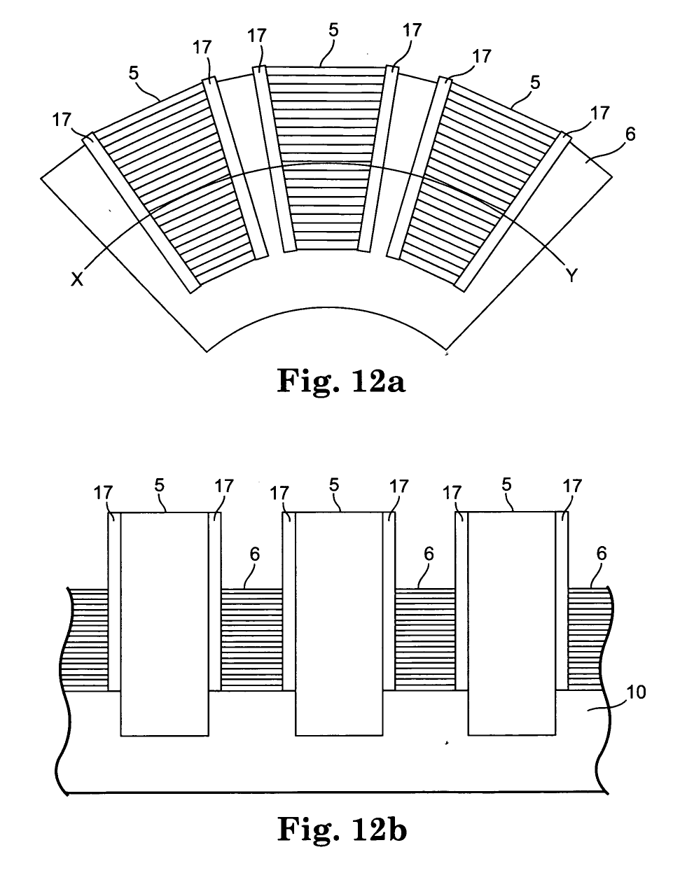

Similarly, FIG. 12 indicates the layer of dust material 17, which is developed for covering not only the fitting area with the laminated surface of the stator teeth 5 and that of the stator back core 6, but also the overall laminated surface of the stator teeth 5 in the stator structure shown in FIG. 9.

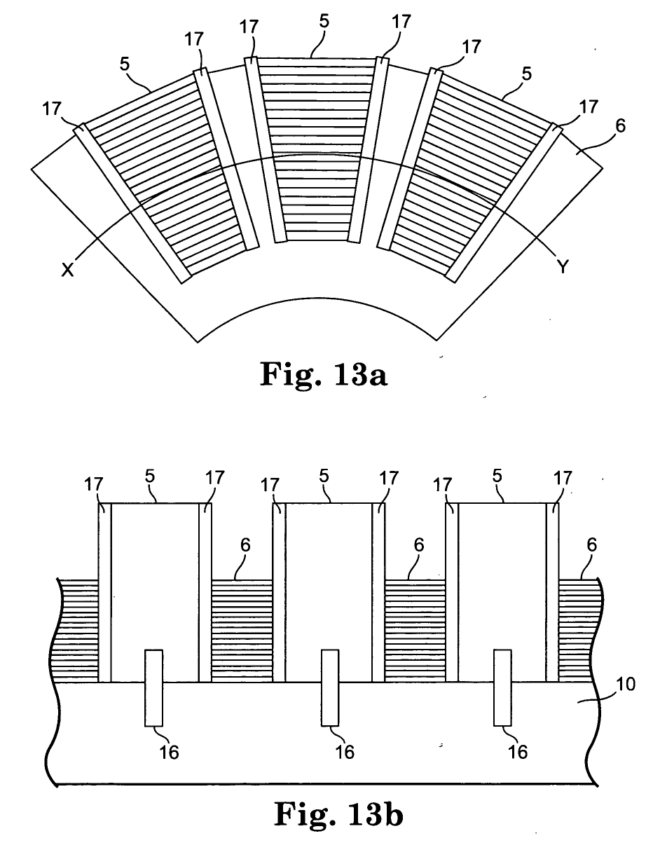

In addition, FIG. 13 indicates the layer of dust material 17, which is developed for covering not only the fitting area with the laminated surface of the stator teeth 5 and that of the stator back core 6, but also the overall laminated surface of the stator teeth 5 in the stator structure shown in FIG. 10.

As above, by installing the layer of dust material 17 for covering the overall laminated surface of the stator teeth 5, the number of manufacturing man-hours may be reduced along with the cost, in comparison with installing the layer of dust material 17 only with the fitting area. It is also possible to use the layer of dust material 17 as an insulator for maintaining the insulation when winding coils around the laminated surface of the stator teeth 5 and the inner/outer circumferential surface.

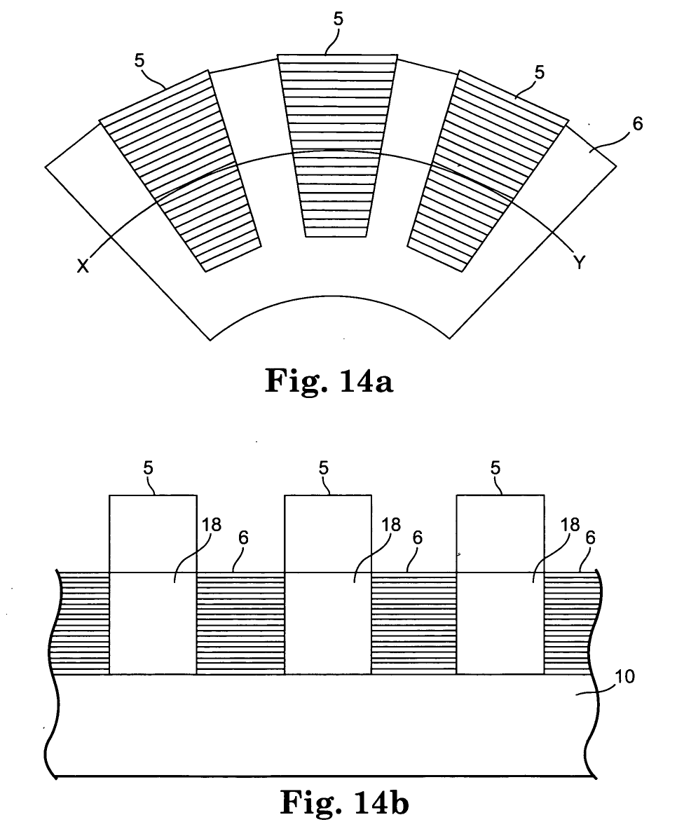

FIG. 14 is a partial summary view of the stator structure for the axial gap rotating electrical device indicating another embodiment of the stator structure for the axial gap rotating electrical device according to the present invention. FIG. 14b shows the XY section of FIG. 14a respectively.

As shown in FIG. 1, the stator structure of the axial gap rotating electrical device comprises a rotor 4 having several permanent magnets 1 evenly placed on the holding member 2 in a circumferential direction, and formed by coupling said holding member to a rotation axis 3. FIG. 1 also includes stator 8 that is placed opposite a rotor 4 along the central axis line of the rotor 4, in which several stator teeth 5 are bonded with said dust material 17 by means of sintering diffusion coupling after filling the joint holes bored in the stator back core 6. Stator teeth 5 are formed by laminating the electromagnetic steel plates with a dust material 18, and the coil 7 winds around respective stator teeth 5. In addition, case 10 for holding a rotation axis 3 rotatably via a bearing 9 as well as fixing a stator 8 is included. Adhesive agents rather than diffusion coupling can be used filling the joint holes bored in the stator back core 6.

It is thereby possible to prevent the laminated surface of the stator teeth 5 and that of the stator back core 6 from making contact in a way such that their respective lamination crosses at right angles in the interface fit area of the stator teeth 5 and stator back core. Accordingly, the electromagnetic steel plates constituting the stator 8 facilitate an electric current in a central axis line direction of the stator 8, while the electromagnetic steel plate constituting the stator 6 facilitate an electric current in a radial direction of the stator 8. Then, a flux, derived from an excitation current of the stator, generates a loop current between the laminated surface of the stator teeth and that of the stator back core, which inhibits the increase of eddy-current loss and thus iron loss.

For the axial gap rotating electrical device shown in FIG. 1, when the coil 5 is excited by an inverter, not shown in the FIG. 1, a revolving magnetic field is formed in a circumferential direction to the stator. The disk-like rotor 4, in which several permanent magnets 1 with a different polarity are alternately implanted in a circumferential direction, is absorbed and repelled by the rotational magnetic field and rotates at the same speed as the rotational magnetic field.

Various embodiments of the invention have been described. However, the present disclosure is not limited to the embodiments described herein. These and other embodiments are within the scope of the following claims. Embodiments including modifications or changes are applicable to the extent of operation and description of the disclosure.

1. An axial gap rotating electrical device comprising:
a stator that includes one or more stator teeth are fixed to interface fit holes bored in a stator back core, and
a loop current decrease layer formed between a laminated surface of the stator teeth and the stator back core within an interface fit area.

2. The axial gap rotating electrical device of claim 1, further comprising:
a rotor having a plurality of permanent magnets evenly placed on a disk-like holding member in a circumferential direction, wherein the holding member is coupled to a rotation axis and the stator is placed opposite the rotor along a central axis line of the rotor; and
a motor case that holds the rotation axis and fixes the stator back core in place.

3. The axial gap rotating electrical device of claim 1, wherein the one or more stator teeth are formed by a first plurality of layered electromagnetic steel plates, and wherein the stator back core comprises a second plurality of layered electromagnetic steel plates.

4. The axial gap rotating electrical device of claim 1, wherein the one or more stator teeth are coiled with wire and evenly placed in a circumferential direction around the stator.

5. The axial gap rotating electrical device of claim 1, wherein the loop current decrease layer is provided in a depression in a circumferential direction of the stator, wherein the depression is located where the laminated surface of the stator teeth is coupled with the stator core back within the interface fit area.

6. The axial gap rotating electrical device of claim 1, wherein the stator teeth extend to a backside of the stator back core, and wherein a portion of the stator teeth extending to the backside are fixed to additional interface fit holes bored in the case.

7. The axial gap rotating electrical device of claim 6, wherein a plurality of groove pairs extend in a radial direction of the stator for an interface fit, the plurality of groove pairs are created in a backside of the stator teeth and in a portion facing the stator teeth of the case, and stator teeth locking plates corresponding to the groove pairs are fixed to the groove pairs for the interface fit.

8. The axial gap rotating electrical device of claim 7, wherein the one or more stator teeth penetrate the stator back core interface fit holes.

9. The axial gap rotating electrical device of claim 1, wherein the loop current decrease layer is a layer of insulating material.

10. The axial gap rotating electrical device of claim 1, wherein the loop current decrease layer is a layer of dust material.

11. The axial gap rotating electrical device of claim 1, wherein the interface fit holes are filled with a dust material, and wherein the one or more stator teeth are coupled to the dust material that filled the interface fit holes.

12. An axial gap rotating electrical device comprising:
means for rotating a plurality of permanent magnets;
means for generating an electrical current; and
means for preventing a loop current within an interface fit area of the means to generate an electrical current.

13. The axial gap rotating electrical device of claim 12, further comprising means for holding a rotation axis and the means to generate an electrical current.

14. The axial gap rotating electrical device of claim 12, wherein the means for generating an electrical current includes one or more stator teeth fixed within interface holes bored in a stator back core.

15. The axial gap rotating electrical device of claim 14, wherein the means for preventing the loop current within an interface area includes means for insulating the interface fit area between the one or more stator teeth and the stator back core.

16. An electrical device comprising:
a stator that includes one or more stator teeth are fixed to interface fit holes bored in a stator back core, wherein the stator teeth laminates multiple layers of a metal and the stator back laminates multiple layers of a metal;
a rotor having a plurality of permanent magnets evenly placed on a disk-like holding member in a circumferential direction, wherein the holding member is coupled to a rotation axis and the stator is placed opposite the rotor along a central axis line of the rotor;
a motor case that holds the rotation axis and fixes the stator back core in place; and
a loop current decrease layer formed between a laminated surface of the stator teeth and the stator back core within an interface fit area.

17. The electrical device of claim 118, wherein the loop current decrease layer is a layer of dust material.
